(19) United States
(12) Patent Application Publication
(10) Pub. No.: US 2020/0211079 A1
(43) Pub. Date: Jul. 2, 2020

(54) VEHICLE-MOUNTED INFORMATION PROCESSING DEVICE, PROGRAM, AND CONTROL METHOD

(71) Applicant: TOYOTA JIDOSHA KABUSHIKI KAISHA, Toyota-shi (JP)

(72) Inventors: Kana HAMAGAMI, Nissin-shi (JP); Takuya MAEKAWA, Nissin-shi (JP); Yosuke NAKAYAMA, Owariasahi-shi (JP); Akitoshi JIKUMARU, Nissin-shi (JP); Tae SUGIMURA, Miyoshi-shi (JP); Takao HISHIKAWA, Nagoya-shi (JP); Shinichi ADACHI, Takahama-shi (JP)

(73) Assignee: TOYOTA JIDOSHA KABUSHIKI KAISHA, Toyota-shi (JP)

(21) Appl. No.: 16/666,507

(22) Filed: Oct. 29, 2019

(30) Foreign Application Priority Data
Dec. 26, 2018 (JP) 2018-243469

(51) Int. Cl. G06Q 30/06; G06K 9/00

(52) U.S. Cl. CPC G06Q 30/0623; G06K 9/00832; G06K 9/00791

(57) ABSTRACT

A vehicle-mounted information processing device includes a controller, an imaging unit including an out-of-vehicle camera configured to image the outside of a vehicle, and an output unit configured to output information acquired by the imaging unit to an occupant in a vehicle cabin of the vehicle. The imaging unit images an identification mark that is associated with content updated at any time on a service provider side and that changes for each content item. The controller acquires the content associated with the imaged identification mark and outputs the acquired content to the occupant in the vehicle cabin by means of the output unit.

### INCORPORATION BY REFERENCE

The disclosure of Japanese Patent Application No. 2018-243469 filed on Dec. 26, 2018 including the specification, drawings and abstract is incorporated herein by reference in its entirety.

### BACKGROUND

### 1. Technical Field

The present disclosure relates to a vehicle-mounted information processing device, a program, and a control method.

### 2. Description of Related Art

In the related art, there is known a technique in which an identification mark is imaged by an out-of-vehicle camera installed in a vehicle such that content associated with the identification mark is acquired by the vehicle. For example, Japanese Patent No. 5015749 (JP 5015749 B) discloses a vehicle position measurement device that images a barcode or a QR code (registered trademark), which is drawn on a road surface within an indoor facility and includes position information, by using a vehicle-mounted camera and that measures the position of a vehicle based on the position information included in the barcode or the QR code imaged.

### SUMMARY

There is a demand for a store or the like to provide content to an occupant of a vehicle by effectively using an identification mark that is associated with content updated at any time and that changes for each content item instead of using a fixed identification mark that is associated with fixed content such as position information.

The present disclosure provides a vehicle-mounted information processing device, a program, and a control method with which it is possible to contribute to provision of content to an occupant of a vehicle with effective use of an identification mark.

A first aspect of the present disclosure relates to a vehicle-mounted information processing device including a controller, an imaging unit, and an output unit. The imaging unit includes an out-of-vehicle camera configured to image the outside of a vehicle. The output unit is configured to output information acquired by the imaging unit to an occupant in a vehicle cabin of the vehicle. The imaging unit images an identification mark that is associated with content updated at any time on a service provider side and that changes for each content item. The controller acquires the content associated with the imaged identification mark and outputs the acquired content to the occupant in the vehicle cabin by means of the output unit.

A second aspect of the present disclosure relates to a program running on a vehicle-mounted information processing device. The program causing the vehicle-mounted information processing device to perform a step of imaging an identification mark that is associated with content updated at any time on a service provider side and that changes for each content item, a step of acquiring the content associated with the imaged identification mark, and a step of outputting the acquired content to an occupant in a vehicle cabin of a vehicle.

A third aspect of the present disclosure relates to a control method for a vehicle-mounted information processing device. The method includes a step of imaging an identification mark that is associated with content updated at any time on a service provider side and that changes for each content item, a step of acquiring the content associated with the imaged identification mark, and a step of outputting the acquired content to an occupant in a vehicle cabin of a vehicle.

With the vehicle-mounted information processing device, the program, and the control method according to the aspects of the present disclosure, it is possible to contribute to provision of content to an occupant of a vehicle with effective use of an identification mark.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a diagram illustrating a schematic configuration of an information processing system including a vehicle-mounted information processing device according to the embodiment of the present disclosure;

FIG. 2 is a block diagram illustrating a schematic configuration of the vehicle-mounted information processing device according to the embodiment of the present disclosure;

FIG. 3 is a block diagram illustrating a schematic configuration of a first information processing device in FIG. 1;

FIG. 4 is a table illustrating a specific example of information processed by a controller of the first information processing device in FIG. 3;

FIG. 5 is a block diagram illustrating a schematic configuration of a second information processing device in FIG. 1;

FIG. 6 is a sequence diagram illustrating a first example of an operation flow in the information processing system; and

FIG. 7 is a sequence diagram illustrating a second example of the operation flow in the information processing system.

### DETAILED DESCRIPTION OF EMBODIMENTS

Hereinafter, an embodiment of the present disclosure will be described with reference to attached drawings.

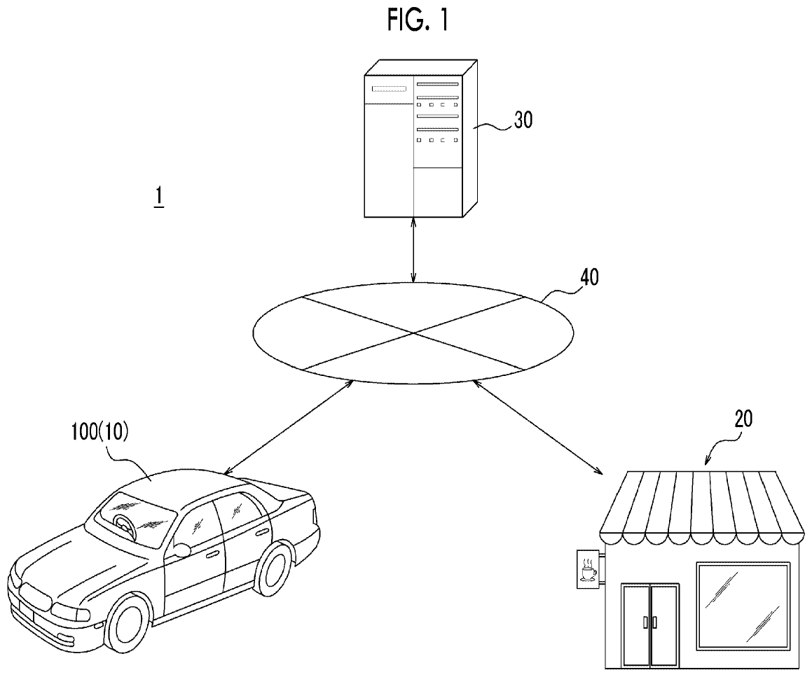

FIG. 1 is a diagram illustrating a schematic configuration of an information processing system 1 including a vehicle-mounted information processing device 10 according to the embodiment of the present disclosure. The configuration and functions of the information processing system 1 relating to the embodiment of the present disclosure will be mainly described with reference to FIG. 1.

The information processing system 1 includes a vehicle 100 in which the vehicle-mounted information processing device 10 is installed, a first information processing device 20, and a second information processing device 30. Each of the vehicle-mounted information processing device 10, the first information processing device 20, and the second information processing device 30 is connected to a network 40 such that the vehicle-mounted information processing device 10, the first information processing device 20, and the second information processing device 30 can communicate with the network 40, examples of the network 40 including a mobile communication network and the Internet.

The vehicle 100 is, for example, an automobile. However, the vehicle 100 is not limited to an automobile and the vehicle 100 may be any vehicle that a person can board. The vehicle 100 is a vehicle driven by a driver. However, the vehicle 100 is not limited thereto and may be a vehicle autonomously driven. Examples of autonomous driving include, levels 1 to 5 defined in the society of automotive engines (SAE). However, the autonomous driving is not limited thereto and may be defined in any manner. For simplicity of description, one vehicle 100 is solely shown in FIG. 1. However, the number of vehicles 100 included in the information processing system 1 may be one or more.

The first information processing device 20 is, for example, one server device or a plurality of server devices communicatable with each other, which is owned by a service provider providing any service to customers including an occupant of the vehicle 100. The first information processing device 20 is not limited thereto. The first information processing device 20 may be any general purpose electronic machine such as a personal computer (PC) or a smartphone and may be another electronic machine dedicated for the information processing system 1. The service provider manages a store, a commercial facility, and the like.

The second information processing device 30 is, for example, one server device or a plurality of server devices communicatable with each other, which is owned by a company such as a credit card company providing a settlement service. The second information processing device 30 is not limited thereto. The second information processing device 30 may be any general purpose electronic machine such as a PC or a smartphone and may be another electronic machine dedicated for the information processing system 1. For simplicity of description, one server device at least one of the attribute constituting the second information processing device 30 is solely shown in FIG. 1 as an example.

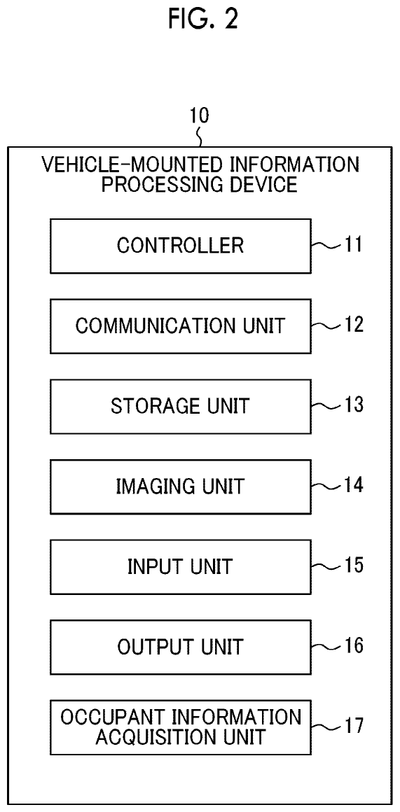

FIG. 2 is a block diagram illustrating a schematic configuration of the vehicle-mounted information processing device 10 according to the embodiment of the present disclosure.

The vehicle-mounted information processing device 10 includes a controller 11, a communication unit 12, a storage unit 13, an imaging unit 14, an input unit 15, an output unit 16, and an occupant information acquisition unit 17. Those components constituting the vehicle-mounted information processing device 10 are connected to each other such that the components can communicate with each other via a vehicle-mounted network such as a controller area network (CAN) or a dedicated line.

The outline of the embodiment is as follows. The imaging unit 14 images an identification mark that is associated with content updated at any time on the service provider side and that changes for each content item. For example, the content includes the product content which the service provider provides to a customer, settlement information associated with a product ordered by a customer, the status of congestion in the store or the commercial facility, facility information in the commercial facility, the availability of a parking lot of the store or the commercial facility, coupon information available at the store or the commercial facility, or the like. The controller 11 may determine whether an identification mark has been imaged by the imaging unit 14 or not. When the controller 11 determines that an identification mark has been imaged by the imaging unit 14, the controller 11 acquires content associated with the imaged identification mark, for example. The controller 11 outputs the acquired content to an occupant in a vehicle cabin of the vehicle 100 by means of the output unit 16. The occupant of the vehicle 100 includes a driver of the vehicle 100 and a fellow passenger. The number of occupants of the vehicle 100 may be one or more.

As described above, according to the embodiment, it is possible to contribute to provision of content to an occupant of the vehicle 100 with effective use of an identification mark. More specifically, since an identification mark imaged by the imaging unit 14 is associated with content updated at any time on the service provider side and changes for each content item, the service provider can appropriately provide content, which the service provider wants to provide to the occupant of the vehicle 100, every time. The occupant of the vehicle 100 can check the above-described various content items in the latest state. In addition, the occupant of the vehicle 100 can easily check various content items while staying in the vehicle cabin without getting off the vehicle 100.

Next, each component of the vehicle-mounted information processing device 10 will be described in detail.

The controller 11 includes one or more processors. The “processor” in the present embodiment is a general-purpose processor, a dedicated processor dedicated for a specific process, or the like. However, the processor is not limited thereto. An electronic control unit (ECU) installed in the vehicle 100 may function as the controller 11. The controller 11 is connected to each component constituting the vehicle-mounted information processing device 10 such that the controller can communicate with each component and controls the operation of the entire vehicle-mounted information processing device 10. In the embodiment, for example, the controller 11 controls the imaging unit 14, the input unit 15, and the occupant information acquisition unit 17 to acquire various kinds of information.

The communication unit 12 includes a communication module that performs communication via a vehicle-mounted network or a dedicated line. The communication unit 12 includes a communication module connected to the network 40. For example, the communication unit 12 may include a communication module conforming to mobile communication standards such as the 4th Generation (4G) and the 5th Generation (5G). A vehicle-mounted communication machine such as a data communication module (DCM) may function as the communication unit 12, for example. In the embodiment, the vehicle-mounted information processing device 10 is connected to the network 40 via the communication unit 12.

The storage unit 13 includes one or more memories. In the embodiment, the “memories” are semiconductor memories, magnetic memories, optical memories, or the like. However, the memories are not limited thereto. Each memory included in the storage unit 13 may function as a main storage device, an auxiliary storage device, or a cache memory, for example. The storage unit 13 stores any information used to operate the vehicle-mounted information processing device 10. For example, a system program, an application program, and various kinds of information acquired by the vehicle-mounted information processing device 10 may be stored in the storage unit 13. Information stored in the storage unit 13 may be able to be updated with information that is acquired from the network 40 via the communication unit 12, for example.

The imaging unit 14 includes an out-of-vehicle camera that images the outside of the vehicle 100. The imaging unit 14 images an identification mark that is associated with content updated as needed on a service provider side and that changes for each content item. The identification mark includes a QR code. An applicable embodiment of the present disclosure is not limited thereto and the identification mark may include any mark such as a barcode. The imaging unit 14 may image such an identification mark while imaging the outside of the vehicle 100 all the time and the imaging unit 14 may image such an identification mark based on an operation performed by the occupant of the vehicle 100 which is performed by using the input unit 15.

The imaging unit 14 or the controller 11 may recognize the identification mark from an image captured by the out-of-vehicle camera by using any image recognition technique.

The input unit 15 receives an input operation performed by the occupant of the vehicle 100. In the embodiment, the input unit 15 includes an input interface included in, for example, a car navigation device. The input unit 15 receives an input operation performed by the occupant of the vehicle 100 to acquire input information input by the occupant of the vehicle 100. The input unit 15 outputs the acquired input information, which is input by the occupant of the vehicle 100, to the controller 11.

The output unit 16 outputs information acquired by the imaging unit 14 to the occupant in the vehicle cabin of the vehicle 100. In the embodiment, the output unit 16 includes a car navigation device. The output unit 16 includes an output device such as a liquid crystal monitor constituting the car navigation device, for example. The car navigation device constituting the output unit 16 outputs content by means of at least one of an image and a voice, for example.

An applicable embodiment of the present disclosure is not limited thereto and the output unit 16 may include any output device that influences at least one of the vision and the hearing of the occupant of the vehicle 100. The output unit 16 may include, for example, any voice output device other than the car navigation device which mainly influences the hearing of the occupant of the vehicle 100. The output unit 16 may include, for example, any image output device other than the car navigation device which mainly influences the vision of the occupant of the vehicle 100.

The occupant information acquisition unit 17 acquires information about the occupant in the vehicle cabin of the vehicle 100. In the embodiment, the occupant information acquisition unit 17 includes an in-cabin camera that images the inside of the vehicle cabin of the vehicle 100. The occupant information acquisition unit 17 acquires the information about the occupant from an image captured by the in-cabin camera, for example. The information about the occupant includes at least one of the attribute of the occupant of the vehicle 100, the number of occupants, the face of the occupant, an expression on the face of the occupant, the orientation of the face of the occupant, the line of sight of the occupant, the blinking state of the occupant, the behavior of the occupant, the speech and action of the occupant, the number of occupants, belongings of the occupant, and driving (boarding) duration, the attribute of the occupant including the age, the sex, the nationality, the race, and the like of the occupant. The occupant information acquisition unit 17 may acquire the information about the occupant all the time and may acquire the information about the occupant at an appropriate timing.

The occupant information acquisition unit 17 may acquire, by using a face recognition technique, the information about the occupant such as the face of the occupant, an expression on the face of the occupant, the orientation of the face of the occupant, the line of sight of the occupant, and the blinking state of the occupant from an image captured by the in-cabin camera. In addition, the occupant information acquisition unit 17 may acquire the information about the occupant from an image captured by the in-cabin camera by using any image recognition technique.

The configuration of the occupant information acquisition unit 17 is not limited to the configuration as described above. The occupant information acquisition unit 17 may include any other image sensor different from the in-cabin camera. The occupant information acquisition unit 17 may include any other sensor connected to a CAN.

For example, the occupant information acquisition unit 17 may include any sound sensor that is installed in the vehicle cabin of the vehicle 100 and is connected to a CAN. The occupant information acquisition unit 17 may acquire the information about the occupant from output information output from the sound sensor, for example. In this case, the information about the occupant may include information about a sound caused by an occupant including the content of conversation performed by an occupant, other voices generated by a behavior of an occupant who emits a spoken language, and a sound generated by a behavior of an occupant who emits other sounds.

The occupant information acquisition unit 17 may acquire the information about the occupant from the output information output from the sound sensor by using a voice recognition technique and any other recognition technique, for example.

For example, the occupant information acquisition unit 17 may include any bid-sensor that is installed in the vehicle cabin of the vehicle 100 and is connected to the CAN. The occupant information acquisition unit 17 may acquire the information about the occupant from output information output from the bid-sensor, for example. In this case, the information about the occupant may include the biological state of the occupant including the brain waves, the cerebral blood flow, the blood pressure, the blood glucose level, the blood amino acid, the heart rate, the pulse, the body temperature, the sensible temperature, a sense of hunger, tiredness, and the like of the occupant.

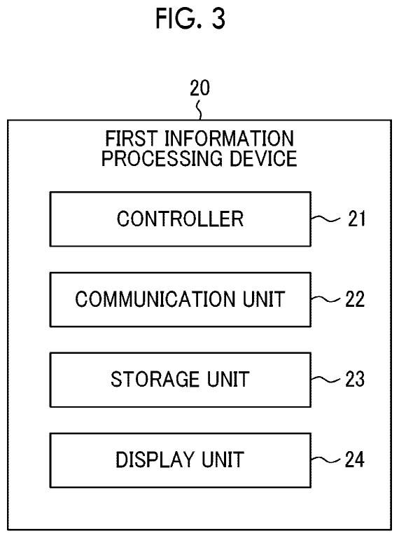

FIG. 3 is a block diagram illustrating a schematic configuration of the first information processing device 20 in FIG. 1. As shown in FIG. 3, the first information processing device 20 includes a controller 21, a communication unit 22, a storage unit 23, and a display unit 24.

The controller 21 includes one or more processors. The controller 21 is connected to each component constituting the first information processing device 20 and controls the operation of the entire first information processing device 20. For example, the controller 21 controls the communication unit 22 such that the information about the occupant is acquired from the occupant information acquisition unit 17 of the vehicle-mounted information processing device 10 via the network 40. For example, the controller 21 controls the storage unit 23 such that information needed to operate the first information processing device 20 is stored in the storage unit 23.

The communication unit 22 includes a communication module connected to the network 40. For example, the communication unit 22 may include a communication module conforming to wired local area network (LAN) standards. In the embodiment, the first information processing device 20 is connected to the network 40 via the communication unit 22.

The storage unit 23 includes one or more memories. Each memory included in the storage unit 23 may function as a main storage device, an auxiliary storage device, or a cache memory, for example. The storage unit 23 stores any information used to operate the first information processing device 20. Information stored in the storage unit 23 may be able to be updated with information that is acquired from the network 40 via the communication unit 22, for example. For example, the storage unit 23 may store a system program and an application.

For example, the storage unit 23 may store the information about the occupant which is acquired by the occupant information acquisition unit 17 of the vehicle-mounted information processing device 10. For example, the storage unit 23 may store information about an identification mark associated with content which the service provider owning the first information processing device 20 wants to provide to a customer and content matching the information about the occupant of the vehicle 100. In addition, for example, the storage unit 23 may store, as big data, purchase data of a customer with respect to a service provided by the service provider, for each customer. Such purchase data may be organized by the controller 21 while being associated with the content of purchase made by the customer at that time, for each of information items about a plurality of occupants acquired in the past by the occupant information acquisition units 17 of the vehicle-mounted information processing devices 10 installed in a plurality of the vehicles 100.

The display unit 24 includes any display device that displays an identification mark to be imaged by the imaging unit 14 of the vehicle-mounted information processing device 10. For example, the display unit 24 includes a liquid crystal monitor. The display unit 24 may be installed at any place in the store, the commercial facility, and the like managed by the service provider. The display unit 24 may be installed in the vicinity of an entrance of a drive-through in the store of the service provider owning the first information processing device 20, a place in the store that faces a public road, and the like. The display unit 24 may be installed in the vicinity of an entrance of a parking lot of the commercial facility of the service provider owning the first information processing device 20, for example.

The controller 21 may generate an identification mark in association with content matching the information about the occupant acquired by the occupant information acquisition unit 17 of the vehicle-mounted information processing device 10. The controller 21 may select, by means of machine learning, the content matching the information about the occupant from among content items stored by the storage unit 23 based on the information about the occupant acquired by the occupant information acquisition unit 17 of the vehicle-mounted information processing device 10, for example. The controller 21 may have any configuration for a learning process in order to perform such a selection process. The controller 21 may refer to, for example, purchase data of customers, which is stored in the storage unit 23 as big data, when selecting optimum content by means of machine learning. The controller 21 causes the display unit 24 to display an identification mark associated with the selected content.

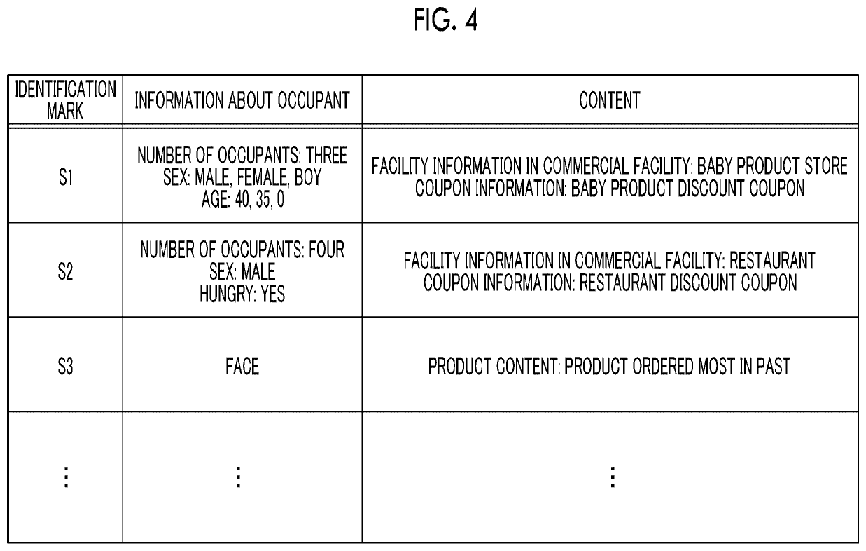

FIG. 4 is a table illustrating a specific example of information processed by the controller 21 of the first information processing device 20 in FIG. 3. The information processed by the controller 21 of the first information processing device 20 will be more specifically described with reference to FIG. 4.

For example, the controller 21 acquires, as the information about the occupant acquired by the occupant information acquisition unit 17 of the vehicle-mounted information processing device 10, information indicating that the number of occupants of the vehicle 100 is three, the occupants are a male, a female, and a boy, and the ages of the occupants are 40, 35, and 0 from the vehicle-mounted information processing device 10. At this time, the controller 21 selects information about a baby product store as the facility information in the commercial facility and information about a baby product discount coupon as the coupon information from among content items stored by the storage unit 23 such that the selected information matches the information about the occupant. The controller 21 generates an identification mark S1 in association with such content matching the information about the occupant and causes the display unit 24 to display the identification mark S1.

For example, the controller 21 acquires, as the information about the occupant acquired by the occupant information acquisition unit 17 of the vehicle-mounted information processing device 10, information indicating that the number of occupants of the vehicle 100 is four, the occupants are males, and the occupants are hungry from the vehicle-mounted information processing device 10. At this time, the controller 21 selects information about a restaurant as the facility information in the commercial facility and information about a restaurant discount coupon as the coupon information from among content items stored by the storage unit 23 such that the selected information matches the information about the occupant. The controller 21 generates an identification mark S2 in association with such content matching the information about the occupant and causes the display unit 24 to display the identification mark S2.

For example, the controller 21 acquires, as the information about the occupant acquired by the occupant information acquisition unit 17 of the vehicle-mounted information processing device 10, the face of the occupant of the vehicle 100 from the vehicle-mounted information processing device 10. At this time, the controller 21 refers to the purchase data of customers stored in the storage unit 23 as well to acquire the number of visits of the occupant of the vehicle 100, the content of purchase made in the past, and the like based on the information about the occupant. At this time, the controller 21 selects, as the product content which the service provider provides to the customer, information about a product ordered most in the past by the occupant of the vehicle 100 from among content items stored by the storage unit 23 such that the selected information matches the information about the occupant. The controller 21 generates an identification mark S3 in association with such content matching the information about the occupant and causes the display unit 24 to display the identification mark S3.

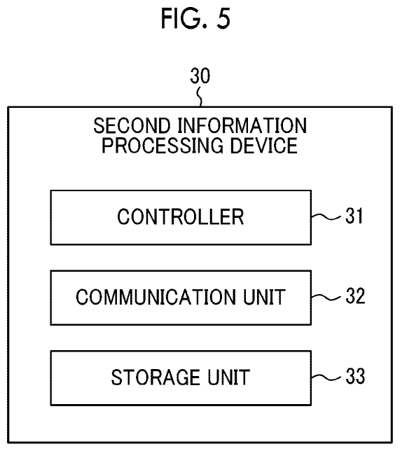

FIG. 5 is a block diagram illustrating a schematic configuration of the second information processing device 30 in FIG. 1. As illustrated in FIG. 5, the second information processing device 30 includes a controller 31, a communication unit 32, and a storage unit 33.

The controller 31 includes one or more processors. The controller 31 is connected to each component constituting the second information processing device 30 and controls the operation of the entire second information processing device 30. For example, the controller 31 controls the communication unit 32 such that settlement information, which will be described later, is acquired from the vehicle-mounted information processing device 10 via the network 40. For example, the controller 31 controls the storage unit 33 such that information needed to operate the second information processing device 30 is stored in the storage unit 33.

The communication unit 32 includes a communication module connected to the network 40. For example, the communication unit 32 may include a communication module conforming to wired local area network (LAN) standards. In the embodiment, the second information processing device 30 is connected to the network 40 via the communication unit 32.

The storage unit 33 includes one or more memories. Each memory included in the storage unit 33 may function as a main storage device, an auxiliary storage device, or a cache memory, for example. The storage unit 33 stores any information used to operate the second information processing device 30. Information stored in the storage unit 33 may be able to be updated with information that is acquired from the network 40 via the communication unit 32, for example. For example, the storage unit 33 may store a system program, an application program, and information relating to a settlement method of the occupant of the vehicle 100 for each occupant.

For example, in a case where the product content which the service provider provides to a customer is included in content, the controller 11 of the vehicle-mounted information processing device 10 acquires, from the input unit 15, input information input at a time when the occupant of the vehicle 100 selects a predetermined product from the product content output from the output unit 16. At this time, the controller 11 transmits, by means of the communication unit 12, settlement information associated with the selected product to the second information processing device 30 on the outside in which information about a settlement method of the occupant of the vehicle 100 is registered. In addition, the controller 11 transmits, by means of the communication unit 12, identification information of the occupant of the vehicle 100 to the second information processing device 30 on the outside.

The controller 31 of the second information processing device 30 compares the identification information of the occupant of the vehicle 100 acquired from the vehicle-mounted information processing device 10 with the information about the settlement method stored in the storage unit 33 to perform a settlement process with respect to the settlement information associated with the selected product. The controller 31 transmits, for example, the result of the settlement process to the vehicle-mounted information processing device 10 and the first information processing device 20 via the network 40. In this manner, the settlement process via the second information processing device 30 is finished.

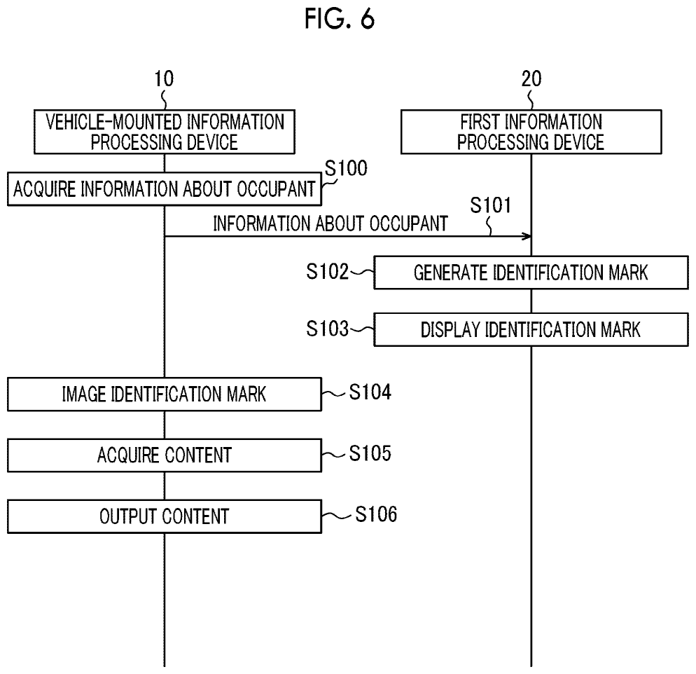

FIG. 6 is a sequence diagram illustrating a first example of the operation flow in the information processing system 1. FIG. 6 illustrates an example of a flow until provision of content to the occupant of the vehicle 100 which is performed between the vehicle-mounted information processing device 10 and the first information processing device 20. An example of the operation flow in the information processing system 1 will be described with reference to FIG. 6.

Step S100: The controller 11 of the vehicle-mounted information processing device 10 acquires information about the occupant in the vehicle cabin of the vehicle 100 by means of the occupant information acquisition unit 17.

Step S101: The controller 11 of the vehicle-mounted information processing device 10 transmits the information about the occupant acquired in step S100 to the first information processing device 20 by means of the communication unit 12.

Step S102: The controller 21 of the first information processing device 20 generates an identification mark in association with content matching the information about the occupant based on the information about the occupant which is acquired from the vehicle-mounted information processing device 10 in step S101. At this time, the controller 21 may refer to the purchase data of customers, which is stored in the storage unit 23 as big data, as needed.

Step S103: The controller 21 of the first information processing device 20 causes the display unit 24 to display the identification mark generated in step S102.

Step S104: The controller 11 of the vehicle-mounted information processing device 10 images the identification mark displayed on the display unit 24 of the first information processing device 20 in step S103 by means of the imaging unit 14.

Step S105: The controller 11 of the vehicle-mounted information processing device 10 acquires the content associated with the identification mark imaged by the imaging unit 14 in step S104.

Step S106: The controller 11 of the vehicle-mounted information processing device 10 outputs the content acquired in step S105 to the occupant in the vehicle cabin of the vehicle 100 by means of the output unit 16.

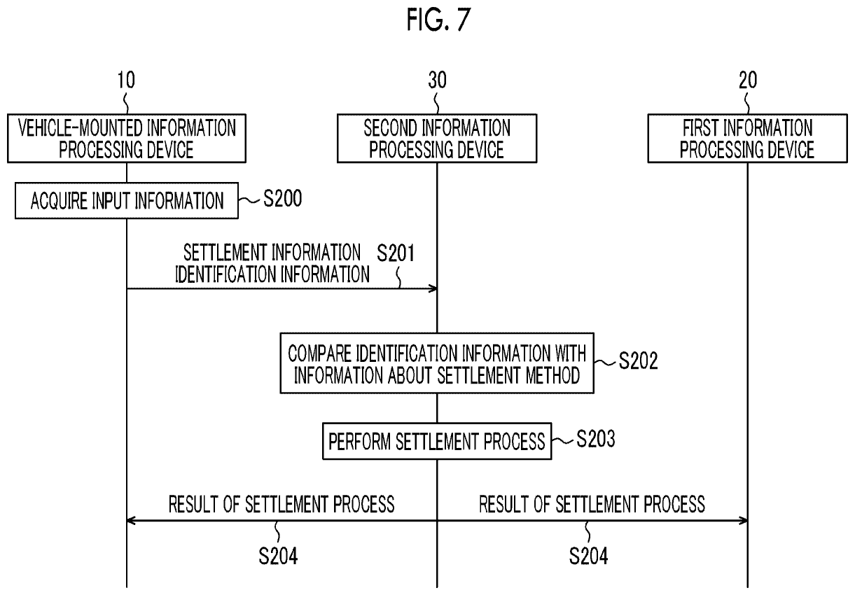

FIG. 7 is a sequence diagram illustrating a second example of the operation flow in the information processing system 1. FIG. 7 mainly illustrates an example of a flow performed between the vehicle-mounted information processing device 10 and the second information processing device 30. More specifically, FIG. 7 illustrates an example of a flow performed between when the occupant of the vehicle 100 performs a selection operation with respect to provided content and when the settlement process is finished. An example of the operation flow of the information processing system 1 will be described with reference to FIG. 7.

Step S200: The controller 11 of the vehicle-mounted information processing device 10 acquires, from the input unit 15, input information input at a time when the occupant of the vehicle 100 selects a predetermined product from the product content output from the output unit 16, for example.

Step S201: The controller 11 of the vehicle-mounted information processing device 10 transmits settlement information associated with the product selected in step S200 to the second information processing device 30 by means of the communication unit 12. In addition, the controller 11 transmits identification information of the occupant of the vehicle 100 to the second information processing device 30 by means of the communication unit 12.

Step S202: The controller 31 of the second information processing device 30 compares the identification information of the occupant of the vehicle 100 acquired from the vehicle-mounted information processing device 10 in step S201 with the information about the settlement method stored in the storage unit 33.

Step S203: The controller 31 of the second information processing device 30 performs a settlement process with respect to the settlement information acquired from the vehicle-mounted information processing device 10 in step S201.

Step S204: The controller 31 of the second information processing device 30 transmits the result of the settlement process in step S203 to the vehicle-mounted information processing device 10 and the first information processing device 20 via the network 40.

As described above, with the vehicle-mounted information processing device 10 according to the embodiment, it is possible to contribute to provision of content to an occupant of the vehicle 100 with effective use of an identification mark. More specifically, since an identification mark imaged by the imaging unit 14 is associated with content updated at any time on the service provider side and changes for each content item, the service provider can appropriately provide content, which the service provider wants to provide to the occupant of the vehicle 100, every time. For example, in a case where product content which the service provider provides to a customer is included in the content, the service provider can appropriately provide the latest current product content to the occupant of the vehicle 100 in accordance with replacement and change or the like of products. As described above, the occupant of the vehicle 100 can check the above-described various kinds of content in the latest state.

For example, when an identification mark associated with content which the service provider wants to provide for a predetermined period is displayed by the display unit 24 of the first information processing device 20 all the time for a corresponding period of time, the first information processing device 20 does not need to perform a process of individually recognizing the vehicle 100 or the like. If the identification mark is not displayed on the display unit 24, the first information processing device 20 needs to detect that the vehicle 100 has arrived at the store, the commercial facility, or the like by using any method in order for the service provider to provide content to the occupant of the vehicle 100. In the case of the information processing system 1 according to the embodiment, the identification mark is displayed on the display unit 24 all the time and the vehicle-mounted information processing device 10 of the vehicle 100 arriving at the store, the commercial facility, or the like automatically acquires content, so that the first information processing device 20 does not need to perform a process relating to individual recognition of the vehicle 100.

In addition, the occupant of the vehicle 100 can easily check various content items while staying in the vehicle cabin without getting off the vehicle 100. For example, in a case where the vehicle-mounted information processing device 10 acquires content based on an identification mark displayed at a place in the store that faces a public road, the occupant of the vehicle 100 can easily acquire content relating to the store by passing by a front side of the store without taking the trouble to enter the store. For example, in a case where the vehicle-mounted information processing device 10 acquires content based on an identification mark displayed in the vicinity of an entrance of a drive-through in the store, the occupant of the vehicle 100 does not need to see a signboard installed in the drive-through at a distance and the occupant can easily check the content by using the output unit 16.

For example, in a case where settlement information associated with a product ordered by a customer is included in the content, the occupant of the vehicle 100 can check the settlement information output from the output unit 16 within the vehicle cabin of the vehicle 100 and can finish a settlement process in the vehicle cabin of the vehicle 100 while operating the input unit 15. At this time, for example, the settlement process may be performed based on the same flow as in the operation flow described with FIG. 7. Accordingly, the occupant of the vehicle 100 can finish the settlement process by operating the input unit 15 solely in the vehicle cabin of the vehicle 100 and thus it is possible to save labor for taking out a wallet at a drive-through or the like and paying money to an employee standing at a counter of the store. Therefore, making an order and settlement at a drive-through or the like are performed smoothly.

Since an identification mark is associated with content matching information about the occupant acquired by the occupant information acquisition unit 17, the service provider can provide content, to which the occupant of the vehicle 100 is attracted, to the occupant of the vehicle 100 in accordance with the state of the occupant of the vehicle 100 at that time. The occupant of the vehicle 100 can receive very satisfactory content matching the current state of the occupant, from the service provider.

The vehicle-mounted information processing device 10 can acquire information about the occupant as visual information by acquiring the information about the occupant from an image captured by the in-cabin camera. Accordingly, the first information processing device 20 can accurately select content matching the information about the occupant based on the visual information.

The vehicle-mounted information processing device 10 can acquire various kinds of information about the occupant, which cannot be acquired with the visual information, by acquiring information about the occupant of the vehicle 100 from output information output from any sensor that can acquire information about the occupant. For example, the vehicle-mounted information processing device 10 can acquire information about a sound caused by the occupant, which cannot be acquired with the visual information, from output information output from the sound sensor. For example, the vehicle-mounted information processing device 10 can acquire a slight emotional change, which cannot be acquired with the visual information, as the biological state of the occupant from output information output from the bid-sensor.

Since the vehicle-mounted information processing device 10 transmits settlement information to the second information processing device 30 based on input information input when the occupant selects a product, the occupant of the vehicle 100 can finish a settlement process in the vehicle cabin of the vehicle 100 while operating the input unit 15. Accordingly, making an order and settlement are smoothly performed and thus the convenience of the occupant of the vehicle 100 is improved.

The present disclosure has been described based on the drawings and examples. However, it should be noted that various changes or modifications can be easily made by those skilled in the art based on the present disclosure. Accordingly, those changes or modifications should be construed as being included within the scope of the present disclosure. For example, the functions or the like included in each means or each step can be rearranged without logical inconsistency, and a plurality of means or steps can be combined with each other or be divided.

For example, in the above-described embodiment, each component of the vehicle-mounted information processing device 10 is installed in the vehicle 100. However, a configuration in which a part of or the entire processing operation performed by each component of the vehicle-mounted information processing device 10 is performed by any electronic machine such as a smartphone or a computer can also be adopted.

For example, a configuration in which a general-purpose electronic machine such as a smartphone or a computer functions as at least one of each component of the vehicle-mounted information processing device 10, the first information processing device 20, and the second information processing device 30 according to the embodiment can also be adopted. For example, a program in which the contents of a process for realizing each function of the communication unit 12 according to the embodiment are written is stored in a memory of an electronic machine and the program is read and executed by a processor of the electronic machine. Accordingly, the present disclosure according to the embodiment can also be realized as a program that can be executed by a processor.

In the above-described embodiment, the vehicle-mounted information processing device 10 and the first information processing device 20 are connected to each other via the network 40 such that the vehicle-mounted information processing device 10 and the first information processing device 20 can communicate with each other. However, the vehicle-mounted information processing device 10 and the first information processing device 20 may be directly connected to each other not via the network 40 by using any communication method such that the vehicle-mounted information processing device 10 and the first information processing device 20 can communicate with each other.

What is claimed is:

1. A vehicle-mounted information processing device comprising:
a controller;
an imaging unit including an out-of-vehicle camera configured to image an outside of a vehicle; and
an output unit configured to output information acquired by the imaging unit to an occupant in a vehicle cabin of the vehicle, wherein:
the imaging unit images an identification mark that is associated with content updated at any time on a service provider side and that changes for each content item; and
the controller acquires the content associated with the imaged identification mark and outputs the acquired content to the occupant in the vehicle cabin by means of the output unit.

2. The vehicle-mounted information processing device according to claim 1, further comprising an occupant information acquisition unit configured to acquire information about the occupant in the vehicle cabin of the vehicle, wherein the identification mark is associated with the content matching the information about the occupant acquired by the occupant information acquisition unit.

3. The vehicle-mounted information processing device according to claim 2, wherein the occupant information acquisition unit includes an in-cabin camera imaging an inside of the vehicle cabin of the vehicle and acquires the information about the occupant from an image captured by the in-cabin camera.

4. The vehicle-mounted information processing device according to claim 1, further comprising:
a communication unit; and
an input unit configured to receive an input operation performed by the occupant of the vehicle, wherein:
the content includes product content which the service provider provides to a customer; and
when the controller acquires, from the input unit, input information input at a time when the occupant of the vehicle selects a predetermined product from the product content output from the output unit, the controller transmits, by means of the communication unit, settlement information associated with the selected product to an external information processing device in which information about a settlement method of the occupant of the vehicle is registered.

5. The vehicle-mounted information processing device according to claim 1, wherein:
the output unit includes a car navigation device; and
the car navigation device outputs the content by means of at least one of an image and a voice.

6. The vehicle-mounted information processing device according to claim 1, wherein the identification mark includes a QR code.

7. A program running on a vehicle-mounted information processing device, the program causing the vehicle-mounted information processing device to perform
a step of imaging an identification mark that is associated with content updated at any time on a service provider side and that changes for each content item,
a step of acquiring the content associated with the imaged identification mark, and
a step of outputting the acquired content to an occupant in a vehicle cabin of a vehicle.

8. A control method for a vehicle-mounted information processing device, the method comprising:
a step of imaging an identification mark that is associated with content updated at any time on a service provider side and that changes for each content item;
a step of acquiring the content associated with the imaged identification mark; and
a step of outputting the acquired content to an occupant in a vehicle cabin of a vehicle.
